(19) United States
(12) Patent Application Publication
(10) Pub. No.: US 2008/0186717 A1
(43) Pub. Date: Aug. 7, 2008

(54) Compact In-Grade Luminaire

(75) Inventor: Neil Ruberg, Spring Grove, PA (US)

Correspondence Address: MIDDLETON & REUTLINGER, 2500 BROWN & WILLIAMSON TOWER, LOUISVILLE, KY, 40202, US

(73) Assignee: Genlyte Thomas Group LLC, Louisville, KY (US)

(21) Appl. No.: 12/020,966

(22) Filed: Jan. 28, 2008

Related U.S. Application Data
(60) Provisional application No. 60/887,602, filed on Feb. 1, 2007.

(51) Int. Cl. F21V 15/00

(52) U.S. Cl. 362/365

(57) ABSTRACT

The invention comprises a compact in-grade luminaire having a lamp module bracket assembly and lamp closure band, a lamp module assembly having a reflector and a lamp housing, a ballast assembly, and a socket assembly that dissipates heat. The in-grade luminaire may be used with wall wash and other types of reflectors.

### CROSS-REFERENCE TO RELATED APPLICATIONS

This application, under 35 U.S.C. § 119(e), claims priority to, and benefit from, U.S. Provisional Application No. 60/887,602, filed on Feb. 1, 2007, entitled, “Compact In-Grade Luminaire,” listing the above-referenced individuals as joint inventors.

### BACKGROUND OF THE INVENTION

1. Field of the Invention

The present invention relates to a compact in-grade or in-ground luminaire. More particularly, the present invention relates to an in-grade luminaire for outdoor commercial lighting or larger residential lighting.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a section view of one embodiment of a luminaire;

FIG. 2 shows one embodiment of a luminaire of the invention;

FIG. 3 shows one embodiment of a cutaway of a ballast assembly of the invention;

FIG. 4 shows one embodiment of a bracket assembly of the invention;

FIG. 5 shows one embodiment of a lamp module assembly of the invention; and

FIG. 6 shows one embodiment of a lamp module assembly of the invention;

FIG. 7 shows side sectional view of an exemplary luminaire;

FIG. 8 shows a side sectional view with the lamp module pivoted;

FIG. 9 shows one embodiment of a closure ring of the invention;

FIG. 10 shows an exploded view of the socket assembly;

FIG. 11 shows a side view of a reflector;

FIG. 12 shows a top perspective view of the reflector;

FIG. 13 shows a side sectional view of the luminaire with ray tracings;

FIG. 14 shows a side view of the reflector with ray tracings; and,

FIG. 15 shows an alternative embodiment of a lamp module bracket.

### DETAILED DESCRIPTION OF THE INVENTION

While this invention is capable of embodiments in many different forms, multiple embodiments are shown in the figures and will be herein described in detail. The present disclosure is to be considered an exemplification of the principles of the invention and is not intended to limit the broad aspects of the invention to the embodiments illustrated.

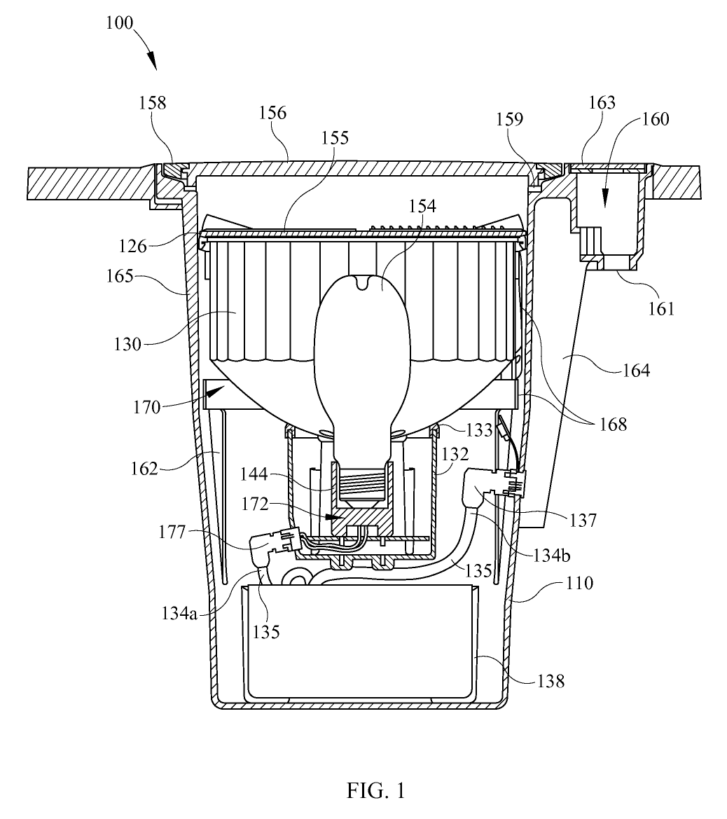

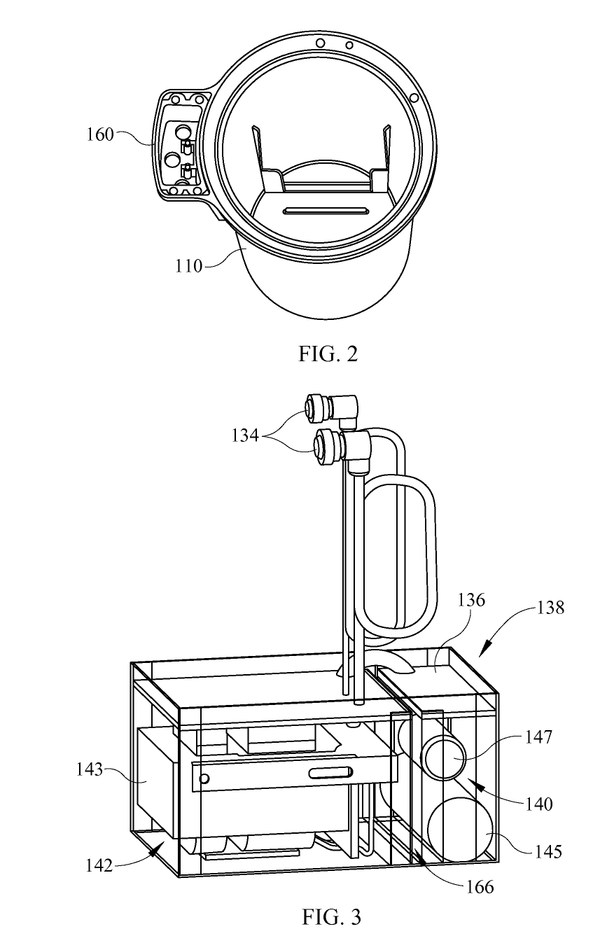

Referencing initially FIGS. 1 and 2, the compact in-grade luminaire 100 of one embodiment of the invention is designed specifically for outdoor commercial lighting applications but may also be used in larger residential lighting applications that require an in-ground luminaire with a great deal of light output. The invention may be installed in dirt, gravel, concrete, decorative stone or similarly acceptable substrate materials directly, but it may also be secured in place via a mounting accessory such as a concrete pour kit or concrete mounting frame.

The invention may be powered by one of several voltage and frequency combinations either alone or in electrical communication with one or more other luminaires. The luminaire 100 may contain a light source of various types, but the wattage of the light source is approximately 400 watts. The design of the invention is such that the temperatures inside the luminaire 100 are within safe operating limits as determined by third party safety agencies, including Underwriters Laboratories (UL). The invention may contain internal and/or external luminaire accessories including, but not limited to, rock guards, directional shields, directional louvers and source shields. The enclosure 110 is generally cylindrical in shape. An upper portion of the enclosure 110 has a first larger diameter. The second lower portion of the enclosure 110 has a smaller diameter. The middle portion of the enclosure 110 tapers between the upper and lower portions. However, such description should not be considered limiting of the enclosure shape.

The luminaire enclosure 110 provides approximately 1750 cubic inches of air volume within it, part of which is used to house the internal components of the luminaire 100. The unused air volume inside the luminaire enclosure 110 provides the means for distributing heat, via convection, to cooler areas of the enclosure 110. Although this specific volume is described, it is only exemplary and should not be considered limiting.

In one embodiment, the luminaire enclosure 110 is covered by a glass lens 156. The exemplary glass lens 156 is formed of tempered molded borosilicate although alternative materials may be used. The glass lens 156 is secured by a lens ring 158, which may be made of, but not limited to, brass or stainless steel. The lens ring 158 is located in a seat defined by an upper generally peripheral portion of the enclosure 110. However, such construction is not limiting. The lens ring 158 is attached to the luminaire enclosure 110 by fasteners of a suitable type. The lens 156 can be held in place by use of compression limiter pads on the lens ring 158, which aid in preventing the lens ring 158 from being tightened too tightly against the lens 156. If the lens 156 is over tightened, cracks or breakage could result. The compression limiter pads restrict the amount of compression on a main lens gasket 159, which ensures a positive seal. The main glass lens 156 seals against the luminaire enclosure 110 by use of the main lens gasket, which in one embodiment is made of silicone, between the two components.

A wiring compartment 160 may be attached to a side of the luminaire enclosure 110. In one embodiment, the wiring compartment 160 is square and is large enough to hold wires used to make electrical connections. The wiring compartment cover 163 may be made from a brass or stainless steel sheet to provide an aesthetic match with the lens ring 158 or an external accessory. The wiring compartment 160 may attach to the luminaire enclosure 110 through fasteners of a suitable type or may be integrally formed with the enclosure 110. The wiring compartment 160 may further comprise a lower conduit aperture 161.

When the luminaire enclosure 110 has a wiring compartment 160, the luminaire enclosure 110 is approximately 14¾ inches at the narrowest part of the top (across the glass lens 156) and 17¾ at the widest part of the top (across the glass lens and wiring compartment 160). The overall height is approximately 19¼ inches excluding any external accessory. However, these dimensions are merely exemplary and should not be considered limiting.

The luminaire enclosure 110 may be molded from a thermal plastic material with molded-in cavities where the lens ring 158 and wiring compartment cover 163 are attached by fasteners of a suitable type. Exterior ribs 165 extending approximately halfway down the luminaire enclosure 110 provide additional structural rigidity to the enclosure 110. The luminaire enclosure 110 may also have an external wiring channel 164 on the enclosure 110 extending down from the wiring compartment 160 to enclose the wires on three sides. Wires extend down from the wiring compartment 160, pass through the wiring channel 164 and may engage a socket connection inside the luminaire enclosure 110. Such technology is shown and described in U.S. Pat. No. 7,011,436, which is incorporated by reference herein.

### I. Lamp Module Bracket Assembly and Lamp Closure Band

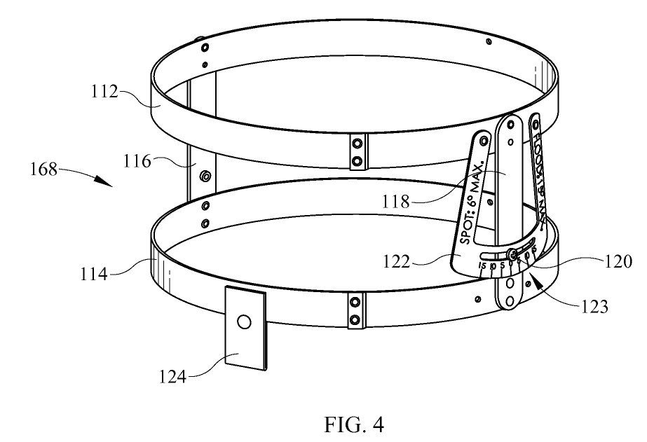

Referring to FIGS. 1 and 4, a lamp module bracket assembly 168 rests inside the luminaire enclosure 110 on housing ribs 162 and may freely rotate easily on housing ribs 162. A LOC-AIM component 124 is used with the bracket assembly 168 that allows the desired rotation position to be locked in place as described further herein. The bracket assembly 168 may be made of several pieces of aluminum sheet metal, or other such parts, comprising a first lower circular band 114 for rotating on the ribs 162 of the luminaire housing 110. The bracket assembly 168 further comprises a second upper circular band 112 that is parallel to the first band 114. The reflector 130 rotates freely inside the bracket assembly 168. Two arms or connectors 116, 118 attach the upper band 112 to the lower band 114 and render the assembly generally rigid. The lower band 114 is held in place perpendicular to the connectors 116, 118 while the upper band 112 is held by one fastener on each connector, which allows the upper band 112 to pivot relative to the connectors 116. A U-shaped scale 122 may attach to the upper band 112 so that, while the upper band 112 is pivoting, the rotation angle can be read from the scale 122.

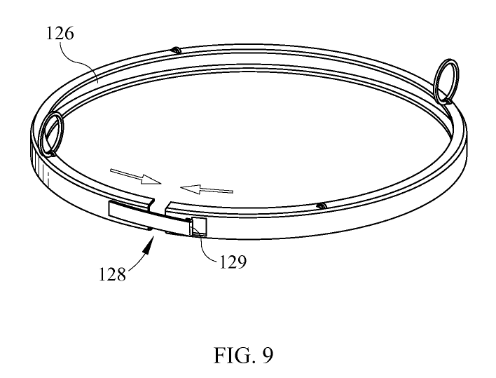

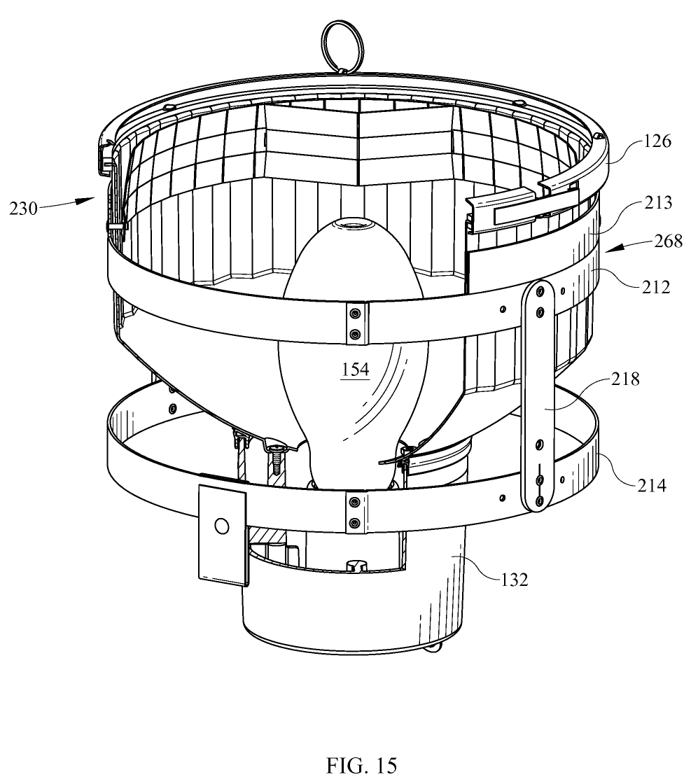

Referring now to FIGS. 1, 4, 7 and 8, operation of the assembly is shown. The lamp module bracket assembly 168 utilizes an easy-to-use scale 122 with angle measurements 123 thereon so that the desired angle can be selected for the luminaire 100. A stationary indicator 120 is used to measure movement of the scale 122. The indicator 120 is located on the connector 118 and indicates angular position of the band 112 on the scale 122. Since this scale 122 is the same for all applicable versions, the luminaire 100 aiming angle can be determined for the lighting application, accurately set for not only that particular luminaire 100 but also be used for all the luminaires in that job. This ensures that the desired lighting results and the actual results are actually the same. Additionally, according to an alternative embodiment, a bracket assembly 268 (FIG. 15) is depicted with the scale removed and the bands 212 and 214 configured to be parallel to one another.

As previously discussed, the lamp module bracket assembly 168 of FIG. 1 has an upper band 112 and a lower band 114. Even with the tight space in the luminaire enclosure 110 that the assembly fits into, the top band's pivot point is located close to the top of the assembly where the reflector flange rests on it. This design feature, when coupled with the small diameter of the lamp housing 132, maximizes the total angular tilting amount of the lamp module assembly 170 in a confined space. Once the desired angle of tilt is set on the scale 122, the bracket assembly 168 can be tightened to ensure the angle stays set. The locking bracket 124 on the lower band 114 can slide around such that once the axial rotation of the bracket assembly 168 and lamp module assembly 170 is determined, the locking bracket 124 can be secured in place to the band 114. This, along with locking the tilt, allows the lamp module bracket assembly 168 to be placed back in the same position after it has been removed without having to worry about repositioning of the lamp module assembly 170. This feature has been termed SURE-AIM.

Turning now to FIG. 4, the design features mentioned above provide a further benefit when used in conjunction with one another—a considerable amount of lamp module assembly 170 aiming within a confined area. In order to be competitive with this design, the luminaire 100 requires the ability to aim the lamp 154 in any of various methods such as plates to tilt the lamp's socket, a fastener that allows the user to “dial” in the aim they wish to have, complex cam features that dictate the angle, etc. The invention utilizes the lamp module bracket assembly 168 to specify the angle and a fastener to lock the angle in place. Once the angle is set, as described previously, the bracket assembly 168 and lamp module assembly 170 can be placed into the luminaire enclosure 110 at the desired angle. The lamp housing's small outer diameter, in comparison to the reflector's outer diameter, allows the lamp module assembly 170 to rotate freely throughout the various reflectors' designed angular range due to the bracket assembly's pivot point being close to the top of the bracket assembly 168. The pivot point is located as close to the reflector's largest outer diameter as possible so that the flange primarily only rotates and does not move closer to the luminaire enclosure 110. This design feature allows a large lamp module assembly 170 to fit within a confined area but still be able to tilt up to 15 degrees from vertical while also allowing the lamp module bracket assembly 168 and lamp module assembly 170 to have 360 degree axial rotation.

Referring now to FIGS. 1 and 7-9, the lamp module assembly 170 is enclosed by means of a lamp module band 126. The lamp module band 126, or C-shaped closure band, holds the lamp module lens 155 against the reflector gasket and the reflector 130. The closure band 126, depending on construction, may also hold an internal accessory as well as the parts previously mentioned. A latch 128 at the open end holds the components together when it is secured into the latch opening on the other side of the open end. In order to apply the latch 128, the band 126 must be compressed so that both ends of the open area move towards one another, which allows a hook portion 129 of the latch 128 to connect with the latch opening. The compressive force on the band constricts against the reflector gasket, which ensures that the band 126 does not bend too much. Once the latch 128 is secured and the band 126 is released, the reflector gasket expands back to its normal shape. This expansion helps to enlarge the open area of the band 126, which further enables a positive lock of the closure band 126. The process for installing and removing the closure band 126, especially beneficial for replacing the light source, is toolless and provides a convenient method to enter the lamp module assembly 170. It should be noted that this description discusses the use of two rings in the lamp bracket assembly 168, but actual construction is not limited and could use more, less, or none for operation of the luminaire. Further, it should also be noted that in at least one embodiment, the lamp module lens 155 may be removed as well as the lamp module band 126. Such embodiment is referred to as a single lens luminaire or fixture.

Referring now to FIG. 15, an alternative lamp module bracket assembly 268 is depicted. The lamp module bracket assembly 268 comprises a first upper band 212 and a second parallel lower band 214. The upper and lower bands 212, 214 are connected by an arm 218, which extends vertically there between. The arm 218 is fastened, for example by rivets, to both the upper and lower bands 212, 214 in such a manner that the upper band 212 cannot pivot relative to the lower band 214 about a horizontal axis, as in the embodiment depicted in FIG. 4. This configuration is useful as a wall wash system. A wall wash reflector incorporates an upper band 212 that does not pivot and does not utilize scale 122. Connected to the reflector 230 is a collar or band 213, which may be riveted to the reflector 230. The collar 213 has a diameter which is substantially equivalent to diameter of the upper band 212, so that the reflector assembly 230 is seated on the upper band 212, and can either rotate on the upper band or with the assembly 268 about a vertical axis. This reflector band 213 retains the lamp module assembly 170 closer to the top of the enclosure 110, rather than on lamp module band 126, to provide the desired light output and alleviate some thermal issues. Thus in the depicted embodiment, the assembly 268 allows for rotation about a vertical axis, however pivoting motions about a horizontal axis cannot occur, due to the construction of the components.

### II. Lamp Module Assembly

Referring now to FIGS. 1 and 5-8, a lamp module assembly 170 is depicted. The lamp module assembly 170, which comprises a reflector 130 and the lamp housing 132, fits in the luminaire enclosure 110 and contains the light source or lamp 154. The lamp module assembly 170 is connected by the cordset 134a to the ballast assembly 138. The lamp module assembly 170 comprises a lamp housing 132 and the reflector 130. The lamp housing 132 may be made from molded thermal plastic material with threaded inserts molded thereon for attaching fasteners. The lamp housing 132 may also be molded from other materials. A hole is located near the bottom of the lamp housing's 132 side wall, which is where the ballast assembly's cordset 134a connects to the lamp module assembly 170.

The reflector 130 is made from spun aluminum and may additionally have segmented specular sheet aluminum and is mounted directly on the lamp housing 132. The reflector 130 may be chemically treated to produce a diffuse or specular finish. The reflector 130 mounts to the lamp housing 132 by sitting on a gasket 133 that cradles the upper edge of the lamp housing 132 and is secured in place by fasteners that attach to some of the lamp housing's molded-in inserts.

A socket assembly 172 sits in the bottom of the lamp housing 132, and a lamp 154 may be screwed or otherwise inserted into the socket assembly 172. The reflector 130 may extend approximately six inches above the lamp housing 132. The reflector 130 acts as the upper portion of the lamp module assembly 170 and does not need to be enclosed in another enclosure.

The upper edge of the reflector 130 incorporates a flange where a reflector gasket is attached. This reflector gasket, for single lens fixtures, rests on top of the lamp module bracket assembly 168 without being secured so that the lamp module assembly 170 can rotate about a vertical axis or pivot about a horizontal axis with movement of the lamp module bracket assembly 168. The reflector 130 design differs depending on the desired light output such as spot, flood or wall wash. The socket assembly 172 comprises a socket 144 and, depending on the fixture version, a socket plate that helps thermally isolate the socket 144 and receptacle's wiring from the rest of the lower housing. A secondary thermal plate or plates helps to further thermally isolate the socket and receptacle's wiring from the rest of the lower housing.

For applicable fixture versions, a clear flat lamp module lens 155 sits on the top side of the reflector gasket and is secured to the reflector 130 by a lamp module band. The lamp module band 126 may be made from spun aluminum metal with a break in the band so that it can be opened and placed around the reflector's flange and the lens. A metal tab or latch 128 that is welded to the lamp module band 126 latches the open section of the band 126 together and holds it closed. For these fixture versions, this lamp module band 126 rests on top of the lamp module bracket assembly 168 without being secured to the lamp module assembly 170 so that the lamp module assembly 170 can rotate inside the lamp module bracket assembly 168.

The optical designs for the lamp module assembly 170 demonstrate a way to produce desirable amounts of light by not being constrained to having a reflector inside the housing; rather, the reflector 130 can be directly attached to the lamp housing. This provides a means of light output control while still enclosing the lamp components inside. This construction method allows for cooler lamp operations as well. The air volume inside the lamp module assembly 170 is maximized by making the reflector 130 part of the lamp module assembly 170.

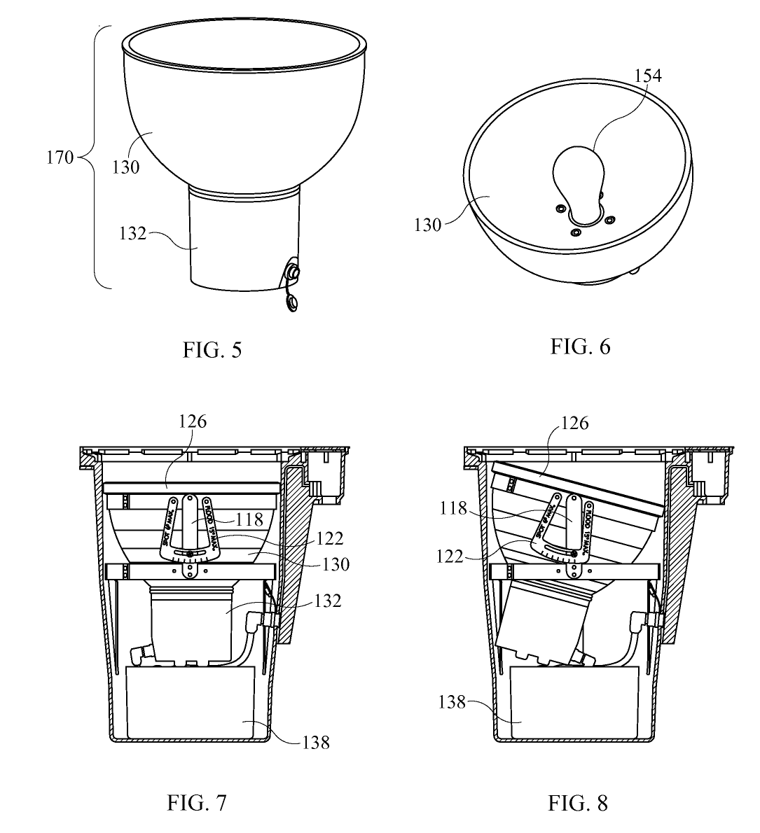

As shown in FIGS. 5 and 7 the lamp module assembly 170 consists of a spun metal upper reflector 130 and a molded composite plastic lamp housing 132 with a rubber gasket sandwiched in between the two parts. The figures only show one possible construction of the lamp module assembly 170 however other constructions, of course, are possible with a similar design. These other constructions may include different reflectors and may or may not have the lamp module closure ring 126 as shown in the figure. For example, four bosses, which are depicted in exemplary fashion may be 4 inches long equally spaced on a 3.5 inch circle, rise out of the bottom of the lamp housing with threaded inserts at the end. The ends of these bosses make contact with four flat indents on the reflector 130. This contact provides the means of connecting the reflector 130 and the lamp housing 132 while minimizing the contact area, which limits conductive thermal transfer from the reflector 130 to the lamp housing 132. When the four screws fasten the reflector 130 to the lamp housing 132, the gasket 133 between them is being compressed to ensure a positive seal at this location only.

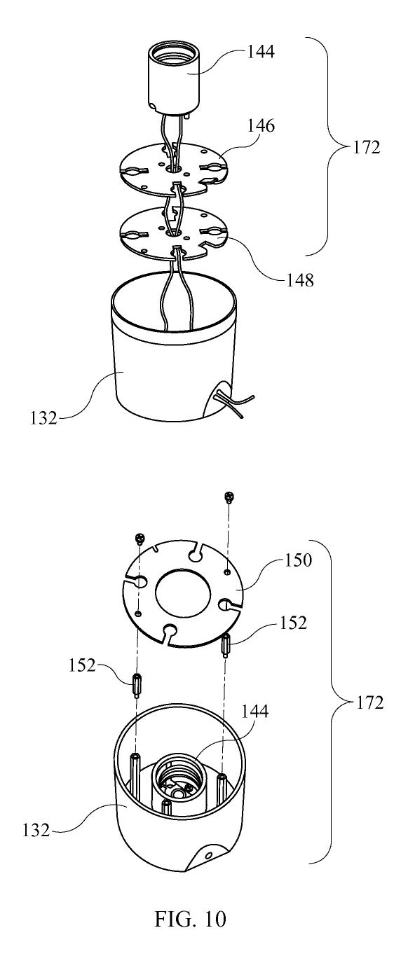

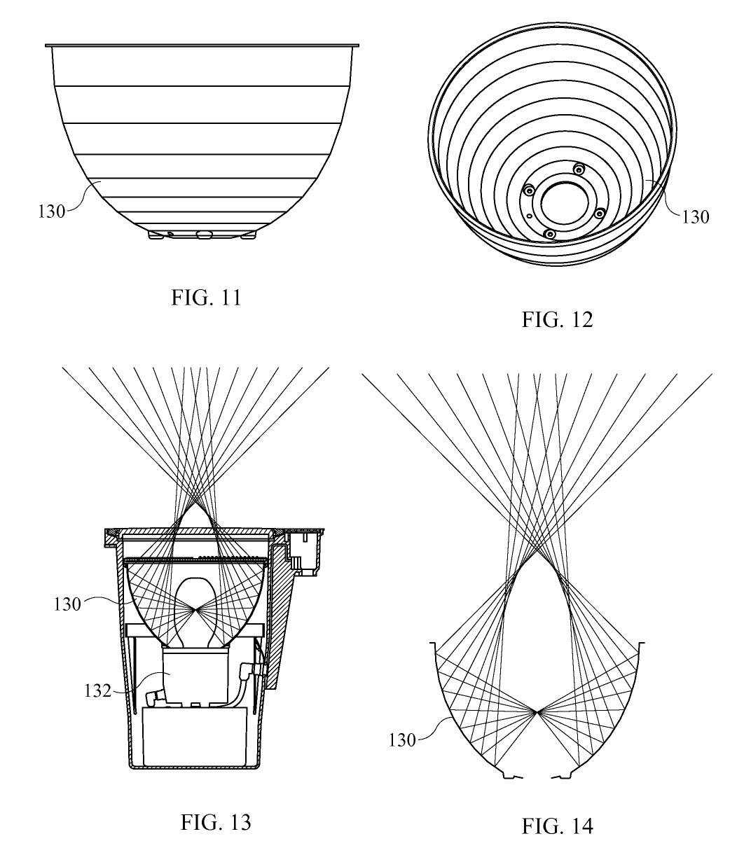

Referring to FIGS. 5-6 and 10, a lamp 154 is positioned in the reflector 130 and only attaches to the socket assembly 172 so the conductive thermal transfer is minimized to the socket assembly 172. In the embodiment depicted in upper portion of FIG. 10, plates 146 and 148 are positioned within the lamp housing 132 as well as the plate 150 of the lower portion of FIG. 10. This three plate configuration is utilized in a metal halide lamp system. Alternatively, the plate 150 may be utilized alone, with a a high pressure sodium lamp system. Thus, the lower portion of FIG. 10 is illustrative of both a metal halide lamp system and a high pressure sodium system while the upper portion is illustrative of a portion of the metal halide lamp system. The socket assembly 172 only makes contact with the lamp housing 132 by fastening directly thereto. The composite plastic lamp housing 132 does not conduct heat efficiently, so this method of socket mounting further reduces the conductive thermal transfer throughout the rest of the lamp module assembly 170.

### III. Ballast Assembly

Referring again to FIG. 1, an encapsulated ballast module assembly 138 is positioned in the bottom of the luminaire enclosure 110. Two cordsets 134 extend out of the ballast assembly 138 wherein one cordset 134a connects with a receptacle in the lamp housing 132 and the other cordset 134b connects with a receptacle extending between the potting channel 164 and the enclosure 110. Wiring extends from the receptacle between enclosure 110 and potting channel 164 upward through potting channel 164 and into the wiring compartment 160. Each cordset 134a, 134b comprises a wire cable 135 and a quick connector 137.

Referring now to FIG. 3, the ballast assembly 138 comprises a ballast 143, a capacitor 145, and where applicable, a starter 147. Potting material (not shown) and sand provide thermal conduction to the ballast assembly 138. The assembly 138 comprises a ballast compartment 142 and a capacitor/starter compartment 140, which may be formed of sheet steel or other strong and lightweight material. Between the first and second compartments 142, 140 is an air gap 166, which inhibits heat transfer between the two compartments and allows heat dissipation.

Referring again to FIGS. 1 and 3, the ballast assembly 138 has the cordsets 134, a ballast 143, a capacitor 145 and an ignitor 147. These components are then encapsulated with an epoxy resin so that the end result is an encapsulated ballast that has simple connections available via the cordsets 134 that extend out of the resin. In order to remove heat, a ¼ inch air gap compartment 166 was added. The air gap 166 allows air to circulate the convective heat and help act as a heat sink to the surrounding areas. Although the exemplary embodiment utilizes a gap size of about ¼ inch, other sizes may be utilized and therefore the exemplary description should not be considered limiting.

Another method for removing heat from the ballast assembly 138 was to utilize an epoxy resin in the ballast assembly 138 that dissipates heat well. The exemplary epoxy resin utilized is Innovative Resin Systems EP288, which draws the heat away from the ballast and other components to ensure that they run cooler and more efficiently. Additionally, the epoxy resin needed to have a filler media that would keep the ballast assembly 138 cost effective and maintain the thermal conductivity provided by the epoxy resin. The media that was eventually chosen as optimal for this epoxy resin was number 3 unground silica sand having a grain fineness of 5. Sand provides a high thermal conductivity value so that the overall thermal conductivity of the ballast module assembly is maintained at a desired level. The low viscosity of the epoxy resin requires grain size of the media to be of concern because too small a grain size would prevent the epoxy resin from filling air spaces in between the sand. The viscosity of the epoxy resin helped dictate that the number 3 size was ideal based on these concerns. The ballast components were changed to a class “N” insulation system for a better insulation material to keep heat away from the path of electricity.

The ballast is encapsulated with an epoxy resin. There is a ¼″ inch gap 166 between the ballast in one compartment and the capacitor and ignitor in another compartment. The epoxy again selected is Innovative Resin Systems EP288 (tradename). The resin draws the heat away from the ballast and the heat dissipation characteristics, and in addition to its ability to withstand high temperatures, was only found with this particular compound. No other epoxy resins on the market were available that could meet these requirements. To our knowledge, this ballast assembly application is the first time this material has been used as part of a luminaire product. This description is illustrative and other resins and materials that perform equally well may be used and therefore may be considered equivalents or alternatively the resin and media could be eliminated as other higher performance enclosures become available.

In addition, the cordsets 134 connected to the ballast assembly 138 needed to be fabricated from higher temperature materials to withstand the increased heat inside the luminaire 100. The custom-manufactured Conxall® quick-connect cordsets 134 utilize standard connector and overmold parts that are molded from high temperature nylon material, while the cordset cable is high temperature Teflon cable. Extensive testing was run to ensure that these cordsets would meet all of the demanding requirements for this high heat application. These materials were selected although such description should not be limiting as other materials may be used.

### IV. Thermal Barrier Plates

Referring now to FIGS. 1 and 10, the luminaire manages heat inside the lamp module assembly 170 by ensuring that the thermal transfer into the lamp module assembly's wiring is reduced by any means. Therefore, this device employs a secondary thermal barrier plate 150 to block the socket and wiring from any convective heat inside the lamp module assembly. The opening in the reflector 130 for the lamp 154 is minimized to reduce the open space around the lamp's neck so that more of the convective heat is contained in the reflector 130 away from the socket and wiring.

The thermal barrier plates 146, 150, of the socket assembly 172 allow more wattage to be placed into a smaller enclosure and to keep the additional heat (from conduction as well as convection) away from electrical component wiring. The lamp 154 produces a considerable amount of heat. Measures needed to be taken to make sure that heat does not affect the wires within the socket 144.

The socket 144 sits on two thermal barrier plates 146, 148 that help lessen the heat that contacts the socket's wires. The first plate 146 underneath the socket 144 is an aromatic polyamide polymer, which reduces thermal conduction from the socket 144. The plate 146 is specifically a synthetic aromatic polyamide polymer low density pressboard sheet (trade name Nomex type 992), which was chosen because it has one of the lowest thermal conductivity values available for non-metallic materials. A second plate 148 underneath the socket 144 is a stainless steel sheet, which was chosen due to the fact that stainless steel has one of the lowest thermal conductivity values of commercially available metals. The stainless steel plate 148 serves to add rigidity to the design and serves as a means to secure the socket 144 without additional fasteners via threaded tapped holes. The wires of the socket 144 pass through the middle of these two plates 146, 148 during assembly so that the convection heat on the wires is greatly minimized. One embodiment of the invention utilizes a secondary thermal barrier plate 150, which is made from the same Nomex type 992 material and is spaced away from the first Nomex plate by standoffs 152 to achieve a useful air gap between them. The secondary thermal barrier plate 150 also partially shields the socket 144 from convective heat. Although materials for the plates 146, 148, 150 are specified, these descriptions should not be considered limiting as alternative materials may be utilized.

When the air temperature around the lamp 154, wiring and other electrical components increases, a cyclical process starts where the components heat up and they become less efficient (i.e. more electricity is converted into heat), which in turn causes the air temperature surrounding the components to heat up further, which then causes the components to heat up, causing a thermal runaway situation. A balance between the air temperature and component temperature must be maintained to assure that the life of the components won't degrade quickly.

The flood optical reflector produces a flood type lighting distribution utilizing a combination of convergent and divergent optical designs to prevent the center area of the lens from overheating. A typical flood optical design commonly utilizes the convergent, or elliptical, optical design that causes the radiant energy produced by the light source to converge at a focal point, which causes the center area of the lens to overheat. With a combination convergent and divergent optical design, the focal point is outside of the luminaire and spread out so that the radiant energy isn't focused to a spot that would overheat and cause a failure as well as inducing more heat into a product where heat reduction is a challenging task.

The foregoing detailed description is given primarily for clearness of understanding and no unnecessary limitations are to be understood therefrom for modifications will become obvious to those skilled in the art upon reading this disclosure and may be made without departing from the spirit of the invention and scope of the appended claims.

1. A lamp module bracket assembly for an in-grade luminaires comprising:
a first band;
a second band, parallel to said first band;
an arm extending from said second band to said first band;
said arm fixed at one end and pivotally connected an opposite end so that one of said first band and said second band rotates relative to the other of said first band and said second band about a horizontal axis.

2. The lamp module bracket assembly of claim 1 wherein said lamp module bracket assembly rotates about a vertical axis relative to an in-grade luminaire enclosure.

3. The lamp module bracket assembly of claim 1 further comprising a scale connected to one of said first band and said second band.

4. The lamp module bracket assembly of claim 1 further comprising an indicator mounted to said arm and stationary relative to said scale.

5. The lamp module bracket assembly of claim 1 further comprising a locking bracket connected to one of said first band and said second band to inhibit rotation of said lamp module bracket assembly.

6. A lamp module bracket assembly for an in-grade luminaires comprising:
an upper band for mounting of a lamp module assembly;
a lower band for mounting said lamp module bracket assembly within an in-grade enclosure;
said upper band pivotable about a horizontal axis relative to said lower band;
said lower band and said upper band rotatable relative to said in-grade enclosure.

7. The lamp module bracket assembly of claim 6 further comprising an arm extending from said lower band to said upper band.

8. The lamp module bracket assembly of claim 7 wherein said upper band is pivotally connected to said arm.

9. The lamp module bracket assembly of claim 7 further comprising a scale connected to one of said upper band and said lower band and a stationary indicator connected to one of said arm or the other of said upper band and lower band.

10. The lamp module bracket assembly of claim 6 further comprising a locking bracket connected to said lower band and inhibiting rotation of said lamp module bracket assembly within said enclosure.

11. A lamp module bracket assembly of claim 6 further comprising a lamp module assembly.

12. A lamp module bracket assembly for an in-grade luminaires comprising:
an enclosure having a lamp module bracket assembly retaining feature;
a lamp module bracket assembly rotatably mounted within said enclosure and rotatably positioned on said retaining feature;
a lamp module assembly connected to said lamp module bracket assembly said lamp module assembly rotatable about a vertical axis.

13. The lamp module bracket assembly for an in-grade luminaire of claim 12, said lamp module assembly rotatable about a horizontal axis.

14. The lamp module bracket assembly for an in-grade luminaire of claim 12 further comprising an upper band and a lower band.

15. The lamp module bracket assembly for an in-grade luminaire of claim 13 said upper band pivotable relative to said lower band.

16. The lamp module bracket assembly for an in-grade luminaire of claim 12 further comprising a scale connected to said lamp module bracket assembly for measuring angular movement of an upper band relative to said lower band.

17. The lamp module bracket assembly of claim 13, said upper band being fixed relative to said lower bracket.

18. A lamp module assembly, comprising:
a socket housing;
a reflector having a lower portion;
a plurality of apertures in said lower portion of said reflector;
a plurality of bosses formed in said socket housing and aligned with said apertures;
at least one fastener extending through said plurality of apertures and engaging said bosses.
